(19) United States
(12) Patent Application Publication
(10) Pub. No.: US 2026/0300589 A1
(43) Pub. Date: Oct. 1, 2026

(54) METHOD OF MATCHING MULTIPLE CHIPS FOR FORMING A SYSTEM-ON-INTEGRATED-CHIPS

(71) Applicant: MEDIATEK INC., Hsinchu City (TW)

(72) Inventors: Chin-Wei Lin, Hsinchu City (TW); Po-Chao Tsao, Hsinchu City (TW); Yu-Lin Yang, Hsinchu City (TW); Tsung-Te Chen, Hsinchu City (TW); Cheng-Tien Wan, Hsinchu City (TW); Tung-Hsing Lee, Hsinchu City (TW)

(73) Assignee: MEDIATEK INC., Hsinchu City (TW)

(21) Appl. No.: 19/096,598

(22) Filed: Mar. 31, 2025

(51) Int. Cl. G06F 30/30; H10P 74/20; G06F 115/02

(52) U.S. Cl. CPC G06F 30/30; H10P 74/203; H10P 74/207; G06F 2115/02

(57) ABSTRACT

The present disclosure provides a method of matching multiple chips for forming a System-on-Integrated-Chips (SOIC). The method comprising: obtaining a first individual transistor parameter of a first die and a second individual transistor parameter of a second die; wherein both the first individual transistor parameter and the second individual transistor parameter are a first type of transistor parameter, and wherein the first die is associated with a first chip, and the second die is associated with a second chip; matching the first chip and the second chip successfully when the first individual transistor parameter of the first die and the second transistor parameter of the second die satisfy a first predetermined condition.

### BACKGROUND

During semiconductor fabrication processes, a wafer may be processed into various electronic components with specific electrical properties. Multiple dies may be cut from a single wafer, and each dies becomes an independent semiconductor component once cut from the wafer. After cutting and testing the wafer, stable and functional dies are packaged to become the familiar chips. An intellectual property (IP) core is technically a reusable unit of logic, cell or integrated circuit (IC) layout design with a defined interface and verified behavior that is licensed to a certain party.

Based on the market's various applications, an IC may be built by combining multiple IP cores of the same type or multiple types. For example, an application-specific integrated circuit (ASIC) may include a central processing unit (CPU) IP core and a graphics processing unit (GPU) IP core, wherein the overall performance of the ASIC is determined by the individual performance of the CPU IP core and the GPU IP core. In the prior art, a CPU IP core and a GPU IP core are randomly selected for forming an IC without considering whether these IP cores have matching characteristics. The characteristic deviations between different IP cores in an IC will reduce the performance of the IC.

### SUMMARY

The present disclosure provides a method of matching multiple chips for forming a System-on-Integrated-Chips (SOIC). The method comprising: obtaining a first individual transistor parameter of a first die and a second individual transistor parameter of a second die; wherein both the first individual transistor parameter and the second individual transistor parameter are a first type of transistor parameter, and wherein the first die is associated with a first chip, and the second die is associated with a second chip; matching the first chip and the second chip successfully when the first individual transistor parameter of the first die and the second transistor parameter of the second die satisfy a first predetermined condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating of a semiconductor wafer according to an embodiment of the present disclosure.

FIG. 2 is a diagram illustrating of two semiconductor wafers according to an embodiment of the present disclosure.

FIG. 3 is a flowchart illustrating a method of matching multiple chips for forming SOICs according to an embodiment of the present disclosure.

FIG. 4 is a flowchart illustrating a method of matching multiple chips for forming SOICs according to another embodiment of the present disclosure.

FIG. 5 is a flowchart illustrating a method of matching multiple chips for forming SOICs according to another embodiment of the present disclosure.

### DETAILED DESCRIPTION

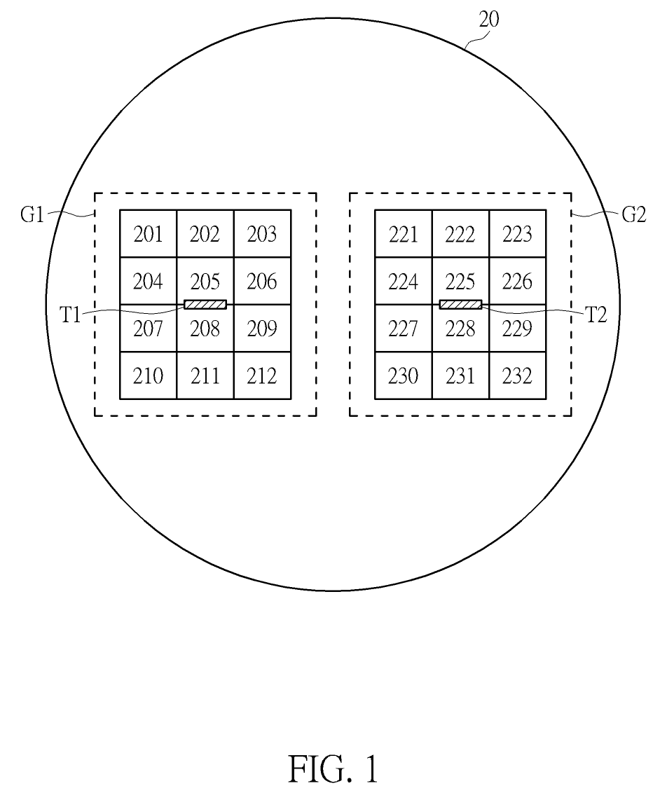

FIG. 1 is a diagram illustrating of a semiconductor wafer. As shown in FIG. 1, a plurality of dies are formed on the wafer 20. In some embodiments, the wafer 20 may include a plurality of die groups, and each die group includes a plurality of dies. In some embodiments, as shown in FIG. 1, a first die group G1 and a second die group G2 are provided on the wafer 20. In the embodiment, it is assumed that the dies in both the first die group G1 and the second die group G2 are functioning properly. Each die in the die group G1 will be made into a corresponding chip through subsequent manufacturing processes (such as cutting, packaging, etc.), and all the dies in the first die group G1 will form a plurality of chips corresponding to the number of dies in the first die group G1 through subsequent manufacturing processes. These chips can be referred to as a first chip group. Similarly, each die in the second die group G2 will also be made into a corresponding chip through subsequent manufacturing processes (such as cutting, packaging, etc.), and all the dies in the second die group G2 will form a plurality of chips corresponding to the number of dies in the second die group G2 through subsequent manufacturing processes. These chips can be referred to as a second chip group. In some embodiments, each die in the first die group G1 is associated with a chip in the first chip group, and each die in the second die group G2 is associated with a chip in the second chip group. In some embodiments, the number of dies in the first die group G1 and the number of dies in the second die group G2 may be equal or different. The number of chips in the first chip group and the number of chips in the second chip group may be equal or different.

In some embodiments, a chip (a first chip) can be selected from the first chip group and another chip (a second chip) can be selected from the second chip group, and these two chips together form a SOIC (System-on-Integrated-Chips).

When selecting chips (the first chip and the second chip) from the first and second chip groups, it is crucial to match the first chip from the first group with the second chip from the second group effectively. Ideally, the parameters of the two chips (or the parameters of the first and second dies corresponding to the two chips chips) should be similar or identical to optimize the performance of the resulting SOIC.

In some embodiments, individual electrical parameters of each die 201 - 212 in the first die group G1 and individual electrical parameters of each die 221 - 232 in the second die group G2 may be measured. Then, one or more of the individual electrical parameters are selected as a reference for matching the first chip and the second chip. The type of the individual electrical parameters (the type of the electrical parameters) may include, for example, the die’s speed, leakage, oxidation thickness, metal line width, gate length, minimum operation voltage, resistivity, conductivity, dielectric constant, carrier concentration, mobility, etc. When selecting the first chip and the second chip to be matched, the first die (from the first die group G1) corresponding to the selected first chip and the second die (from the second die group G2) corresponding to the selected second chip may have one or more similar individual electrical parameters. For example, the first chip and the second chip may have similar die speeds, similar die leakages, or/and similar die minimum operating voltages. Through the above method, the first chip and the second chip with more matched parameters can be selected to achieve better matching, so as to improve the performance of the formed SOIC.

In some embodiments, the number of individual electrical parameters (or electrical parameters) of the dies is quite large, including speed, leakage, oxidation thickness, metal line width, gate length, minimum operating voltage, resistivity, conductivity, dielectric constant, carrier concentration, mobility, etc.; the number may exceed 500. Therefore, when using electrical parameters as a reference for selecting and matching the first chip and the second chip, it is difficult to comprehensively consider more than 500 parameters. For example, only some of the main parameters can be considered, and these main parameters are used as a reference for selecting and matching the first chip and the second chip. However, such selection and matching may result in some unreasonable matching because most of the parameters are ignored.

In some embodiments, the first chip and the second chip may be selected by considering individual transistor parameters of corresponding die. For example, ensuring that at least one individual transistor parameter of the first die (associated with the first chip) closely matches at least one individual transistor parameter of the second die (associated with the second chip) can improve the performance of the resulting SOIC. The at least one individual transistor parameter of the first die and at least one individual transistor parameter of the second die are transistor parameters of the same type. Of course, after selecting the first and second chips, additional chips from both the first and second chip groups can be chosen to form other SOICs. In some embodiments, the type of the individual transistor parameters (or the type of the transistor parameters) of each die may include the die's threshold voltage, channel impedance, contact resistance, on-current, off-current, transconductance, Output Conductance, Gate Capacitance, Source-Drain Resistance, Breakdown Voltage, etc. The number of individual transistor parameters (or transistor parameters) of a die may be around 50, significantly fewer than the number of individual electrical parameters (or electrical parameters) of a die. Consequently, matching the first chip and the second chip based on transistor parameters is more manageable and results in smaller matching errors. In addition, since the number of transistor parameters is about 50, for example, selecting 10 parameters for matching consideration represents 20% of the total, substantially reducing the likelihood of poor matching between the first and second chips and enhancing matching accuracy.

In some embodiments, the individual transistor parameters of each die may be obtained through measurement, simulation, or other methods. In this way, the first chip in the first chip group and the second chip in the second chip group can be selected and matched by directly obtaining the individual transistor parameters of the die, so as to form a SOIC with better performance and better matching.

In some embodiments, a chip may comprise multiple interconnected electronic components, such as transistors, resistors, and capacitors. Transistors, being the fundamental building blocks of computing, provide a concrete measure of a chip's computational power through their count. To ensure device quality and enhance product yield in mass production, each chip must undergo continuous testing at every stage of manufacturing. Commonly, various testing circuits, often called “test keys”, are fabricated alongside the actual device. The performance of these test keys allows for the assessment of the actual device's quality and the detection of component defects that may arise from unexpected processing errors. In current wafer testing techniques that utilize test keys, it is possible to directly measure various individual electrical parameters of each die on a wafer, as well as the overall transistor parameters of each die group. However, in some cases, the individual transistor parameters of each die may not be directly measurable. To address this, the present disclosure proposes a method for indirectly obtaining the individual transistor parameters of each die. As shown in FIG. 1, a first test key T1 is provided in the first die group G1 on the wafer 20, and a second test key T2 is provided in the second die group G2 on the wafer 20. In some embodiments, the first test key T1 can be used to measure the overall electrical parameters value of the first die group G1 and the overall transistor parameters value of the first die group G1. In some embodiments, a value of an overall electrical parameter of the first die group G1 may represent an average/median value of the electrical parameter of all the dies (dies 201-212) in the first die group G1. In some embodiments, a value of an overall transistor parameter of the first die group G1 may represent an average/median value of the electrical parameter of all the dies (dies 201-212) in the first die group G1. In some embodiments, the second test key T2 may be used to measure the overall electrical parameters value of the second die group G2 and the overall transistor parameters value of the second die group G2. In some embodiments, a value of an overall electrical parameter of the second die group G2 may represent an average/median value of the electrical parameter of all the dies (die 221-232) in the second die group G2.

Therefore, the overall electrical parameters and overall transistor parameters of the first die group G1 and the second die group G2 can be obtained through the first test key T1 and the second test key T2, respectively. This enables the establishment of a corresponding relationship between each overall electrical parameter value and the corresponding overall transistor parameter value of the first die group G1, and a corresponding relationship between each overall electrical parameter value and the corresponding overall transistor parameter value of the second die group G2. Of course, we can also obtain more corresponding relationships between each overall electrical parameter value and the corresponding overall transistor parameter value of other die groups. With a substantial dataset, a reliable corresponding relationship between the overall electrical parameters and their corresponding transistor parameters can be determined. This data can then serve as the training set for developing an AI model.

After the AI model is established, the individual electrical parameter value of each die obtained by direct measurement is input into the AI model. The AI model obtains the individual transistor parameter value of each die (or chip) through the prediction of the AI model based on the reliable corresponding relationship between the overall electrical parameter and the corresponding overall transistor parameter. Therefore, in the embodiment of the present disclosure, the individual transistor parameters of each die (or chip) are indirectly obtained through the above method. Then, the selection and matching of SOIC as described above can be implemented.

The following examples are used to describe embodiments of the present disclosure. In some embodiments, the types of overall or individual electrical parameters for a die group or a single die may include speed, leakage, oxidation thickness, metal line width, gate length, minimum operating voltage, resistivity, conductivity, dielectric constant, carrier concentration, and mobility, etc. In some embodiments, the types of transistor parameters, whether overall or individual, for a die group or a single die may include threshold voltage, channel impedance, contact resistance, on-current, off-current, transconductance, output conductance, gate capacitance, source-drain resistance, and breakdown voltage, etc.,.

The speed in overall electrical parameters or individual electrical parameters, and the threshold voltage in overall transistor parameters or individual transistor parameters are selected as examples for explanation. In some embodiments, as shown in FIG. 1, for example, the average speed (i.e., overall speed) of all dies in the first die group G1 measured by the first test key T1 is 10 (without any unit, only expressed as a numerical value), and the average threshold voltage (i.e., overall threshold voltage) of all dies in the first die group G1 is 50 (without any unit, only expressed as a numerical value). For another example, the average speed (i.e., overall speed) value of all dies in the first die group G2 measured by the second test key T2 is 8, and the average threshold voltage (i.e., overall threshold voltage) value of all dies in the second die group G2 is 30. In this way, the corresponding relationship between speed and threshold voltage can be found. Of course, we can also collect more information to find a more accurate correspondence between speed and threshold voltage. Of course, for the sake of simplicity of description, only speed and threshold voltage are used as examples. In practice, more parameters may be associated and corresponded, and the correspondence of multiple parameters may be mutually checked and verified.

Then, the individual electrical parameters of each die can be measured through testing, so that the individual transistor parameters of each die can be estimated or inferred based on the corresponding relationship between the overall electrical parameters and the overall transistor parameters established above. For example, in this embodiment, the individual speed of the die 201 is measured to be 8. According to the corresponding relationship between the overall speed and the overall threshold voltage, it can be estimated or inferred that the individual threshold voltage of the die 201 is 30. For another example, the individual speed of the die 202 is measured to be 10. According to the corresponding relationship between the overall speed and the overall threshold voltage, it can be estimated or inferred that the individual threshold voltage of the die 202 is 50. For another example, the individual speed of the die 203 is measured to be 11. According to the corresponding relationship between the overall speed and the overall threshold voltage, it can be estimated or inferred that the individual threshold voltage of the die 203 is 60. For another example, the individual speed of the die 204 is measured to be 12. According to the corresponding relationship between the overall speed and the overall threshold voltage, it can be estimated or inferred that the individual threshold voltage of the die 204 is 60. For another example, the individual speed of the die 205 is measured to be 7. According to the corresponding relationship between the overall speed and the overall threshold voltage, it can be estimated or inferred that the individual threshold voltage of the die 205 is 20. Therefore, in the embodiment of the present disclosure, based on the corresponding relationship between the overall electrical parameters of the die group and the overall transistor parameters, the individual transistor parameters of the single die can be estimated or inferred by measuring the individual electrical parameters of the single die.

In this embodiment of the disclosure, by amassing a substantial dataset of the relationships between electrical parameters and transistor parameters, a more accurate model can be developed. This, in turn, enables the creation of a more reliable AI model for precisely estimating or inferring the individual transistor parameters of a single die. Consequently, with the individual transistor parameters of each die determined, these parameters can guide the selection and matching of the first chip and the second chip. This process ensures the formation of a SOIC with superior matching.

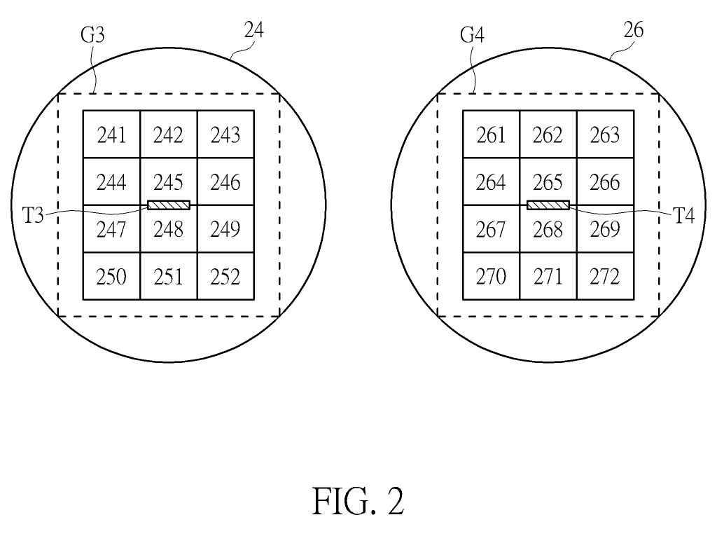

In some embodiments, the plurality of die groups may be located on different wafers. For example, as shown in FIG. 2, the third die group G3 is on the wafer 24, and the fourth die group G4 is on the wafer 26. The third die group G3 includes the dies 241 - 252, and the fourth die group G4 includes the dies 261 - 272. The wafer 24 has a third test key T3, and the wafer 26 has a fourth test key T4. Similar to the example of FIG. 1, each die in the third die group G3 will be manufactured into corresponding chips, these chips may be referred to as a third chip group. Each die in the fourth die group G4 will be manufactured into corresponding chips, and these chips can be referred to as a fourth chip group. A method similar to the above embodiment may be used to select a third chip from the third chip group and a fourth chip from the fourth chip group, and then combine them to form a SOIC.

Therefore, the embodiments of the present disclosure provide a variety of ways to match chips to form SOIC. For example, matching according to at least one individual electrical parameter of the dies corresponding to the chips; matching according to at least one individual transistor parameter of the dies corresponding to the chips. The following will be described in detail with reference to the diagram.

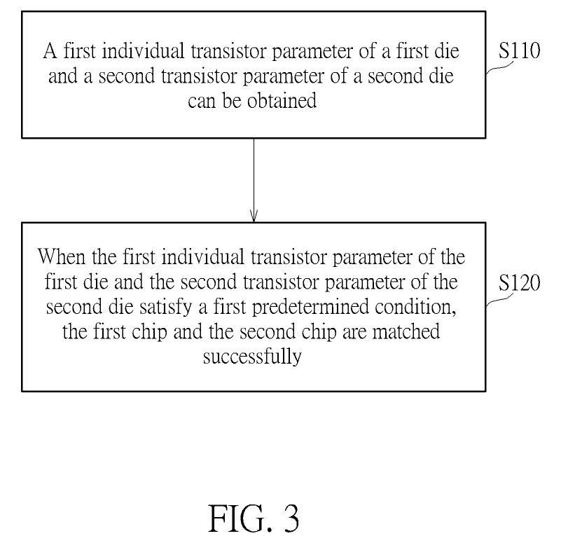

FIG. 3 is a flowchart illustrating a method of matching multiple chips for forming SOICs according to an embodiment of the present disclosure.

S110: a first individual transistor parameter of a first die and a second transistor parameter of a second die can be obtained; and both the first individual transistor parameter and the second individual transistor parameter are a first type of transistor parameter, and the first die is associated with a first chip, and the second die is associated with a second chip;

S120: when the first individual transistor parameter of the first die and the second transistor parameter of the second die satisfy a first predetermined condition, the first chip and the second chip are matched successfully.

In some embodiments, for example, the first transistor parameter may be the threshold voltage of the die, and the second individual transistor parameter is of the same type as the first individual transistor parameter, so the second individual transistor parameter is also the threshold voltage of the die. For another example, the first individual transistor parameter may be the contact resistance of the die, and the second individual transistor parameter is of the same type as the first individual transistor parameter, so the second individual transistor parameter is also the contact resistance of the die. Therefore, in the embodiment of the present disclosure, individual transistor parameters of the same type are used to compare and match two chips.

In some embodiments, the first predetermined condition may comprise the difference between the first individual transistor parameter and the second individual transistor parameter is less than a first predetermined threshold, or the difference is within a first predetermined range, or the ratio between the first individual transistor parameter and the second individual transistor parameter is within a predetermined range, etc. For example, the first predetermined condition may stipulate that the difference between the first individual transistor parameter and the second individual transistor parameter should be less than the first predetermined threshold, such as 4%, 5%, 7%, or another specified value.

In some embodiments, a third individual transistor parameter of the first die and a fourth individual transistor parameter of the second die may also be obtained, wherein the third individual transistor parameter and the fourth individual transistor parameter are transistor parameters of the same type(such as the second type), and the type of the third individual transistor parameter (or the fourth individual transistor parameter) is different from the type of the first individual transistor parameter (or the second individual transistor parameter). For example, the type of the first individual transistor parameter (or the second individual transistor parameter) is the threshold voltage of the die, and the type of the third individual transistor parameter (or the fourth individual transistor parameter) is the contact resistance of the die. Therefore, in subsequent steps, in addition to determining whether the first individual transistor parameter of the first die and the second individual transistor parameter of the second die satisfy the first predetermined condition, it may also be determined whether the third individual transistor parameter of the first die and the fourth individual transistor parameter of the second die satisfy the first predetermined condition or other predetermined condition (such as the second predetermined condition). For example, the second predetermined condition may stipulate that the difference between the third individual transistor parameter and fourth individual transistor parameter should be less than the second predetermined threshold, such as 3%, 4%, 5%, 7%, 8% or another specified value. In some embodiments, the second predetermined condition may differ from the first predetermined condition to accommodate different types of parameters. Of course, in the embodiment of the present disclosure, the fifth individual transistor parameter, the sixth individual transistor parameter, or more individual transistor parameters, etc. can also be obtained, to be used for chip matching judgment. The embodiments of the present disclosure do not limit the number of individual transistor parameters obtained and the number of individual transistor parameter types.

In some embodiments, when the third individual transistor parameter of the first die and the fourth individual transistor parameter of the second die can also be obtained, the method in this embodiment can also include comparing the third individual transistor parameter and the fourth individual transistor parameter. Therefore, in addition to judging whether the first individual transistor parameter of the first die and the second individual transistor parameter of the second die satisfy the first predetermined condition, it is also necessary to judge whether the third individual transistor parameter of the first die and the fourth individual transistor parameter of the second die satisfy the same or different predetermined condition. For example, when (a) the first individual transistor parameter of the first die and the second individual transistor parameter of the second die satisfy the predetermined condition, and when (b) the third individual transistor parameter of the first die and the fourth individual transistor parameter of the second die satisfy the same or different predetermined condition, the first chip and the second chip are successfully matched. Therefore, when (a) and (b) are both met, the first chip and the second chip are successfully matched; when either (a) or (b) is not satisfied, the first chip and the second chip fail to match.

In some embodiments, the first chip may be an IP core of one type, such as a CPU IP core, while the second chip may be an IP core of another type, such as a GPU, memory, or power management IC (PMIC) IP core. Alternatively, both the first and second chips may be IP cores of the same type. However, the specific types of the first and second chips are not restrictive and do not limit the scope of the present disclosure.

In some embodiments, the test keys are simultaneously fabricated with an actual device (be subsequently formed into a die) so that the quality of the actual device can be judged by the performance of the testing circuit and the defects in various component parts due to unexpected processing errors may be found. In some embodiments, various overall electrical parameters of each die group and various overall transistor parameters of each die group may be directly measured. In some embodiments, the individual transistor parameters of each die may be measured by using the test keys or according to subsequent testing steps. However, the individual transistor parameters of each die cannot be directly measured using the test keys.

In some embodiments, in order to obtain the prediction data of the individual transistor parameter(s) of the first die corresponding to the first chip. In the first step, the first type of the individual transistor parameter to be obtained may be determined (for example, the first type may be a threshold voltage). After the first type is determined, in the second step, the first type of overall transistor parameter of the die group is obtained; and the third type of overall electrical parameter of the die group is obtained. The third type may be, for example, speed. In the third step, the first type of the individual transistor parameter of the first die is predicted or estimated based on the corresponding relationship between the first type of overall transistor parameter and the third type of overall electrical parameter, and the third type of a first individual electrical parameter of the first die. The third type of the first individual electrical parameter can be obtained by measuring the first die or the first chip. In some embodiments, obtaining the first type of overall transistor parameter and the third type of overall electrical parameter from the same die group, rather than different die groups, can mitigate negative effects caused by manufacturing variations and other errors.

For example, in the first step, it is determined that the first type of the individual transistor parameter to be obtained is the threshold voltage. In the second step, the threshold voltage in the overall transistor parameter of the die group is obtained to be 30; and the speed in the overall electrical parameter of the die group is obtained to be 8. In the third step, according to the corresponding relationship between the threshold voltage in the overall transistor parameter of the die group being 30 and the speed in the overall electrical parameter being 8, and if the speed in the individual electrical parameter of the first die obtained is 8, it is predicted or estimated that the threshold voltage in the individual transistor parameter of the first die is 30.

Of course, the above example is purely illustrative. In the third step, if the speed among the individual electrical parameters of the first die is not 8 but other values, such as 7, 10, 15, etc. determining the value of the threshold voltage in the individual transistor parameter of the first die requires more data on the corresponding relationships between the overall transistor parameter's threshold voltage of the die group and the speed in the overall electrical parameters. For example, we can continue to measure the overall transistor parameter and overall electrical parameter of each die group of other die groups, so as to obtain more corresponding relationships between the overall transistor parameter and the overall electrical parameter. For example, we can measure the threshold voltage and speed of each die group, so as to obtain more corresponding relationships between the threshold voltage and speed.

Therefore, by collecting the values of the threshold voltage from the overall transistor parameters and the speed from the overall electrical parameters for a large number of die groups, we can establish a wider range and more reliable database, along with corresponding relationships between these two parameters.

In some embodiments, to predict the individual transistor parameter(s) of the first die corresponding to (or associated with) the first chip, the process involves three steps. In the first step, identify the type (such as the first type) of individual transistor parameter to be predicted. In the second step, obtain the overall transistor parameter of the identified type (such as the first type) for the die group; as well as the overall electrical parameter of the third type from the same die group. In the third step, the individual transistor parameter of the first type of the first die is predicted or estimated according to the corresponding relationship between the transistor parameter of the first type and the electrical parameter of the third type, and a first individual electrical parameter of the third type of the first die. The first individual electrical parameter can be obtained by measuring the first die or the first chip.

In some embodiments, predicting the individual transistor parameter(s) of the first die corresponding to (or associated with) the first chip, involves three steps. In the first step, identify the type (such as the first type) of individual transistor parameter to be predicted. In the second step, collect many sets of data, where each set of data includes the overall transistor parameter of this type (such as the first type) and a third type of the overall electrical parameter of the same die group. For example, many sets of data can be obtained by measuring the overall transistor parameter of this type (such as the first type) and a third type of the overall electrical parameter of many die groups. Thus, through the above many sets of data, a more reliable and wider range corresponding relationship between the first type of the transistor parameters and the third type of the electrical parameter can be obtained. In the third step, predict or estimate the first type of the individual transistor parameter for the first die. This prediction is based on the corresponding relationship between the first type of the transistor parameters and the third type of the electrical parameter, and a first individual electrical parameter of the first die. The first individual electrical parameter is the third type of the electrical parameter, and the first individual electrical parameter can be obtained by measuring the first die or the first chip.

In some embodiments, many other sets of data are collected, and each other set of data includes the overall transistor parameter of the first type and a fourth type of overall electrical parameter of the same die group. For example, many other sets of data can be obtained by measuring the overall transistor parameter of the first type and a fourth type of the overall electrical parameter of many die groups. The fourth type is different from the third type. A corresponding relationship between the fourth type of the electrical parameter and the first type of the transistor parameter may be established by collecting many other sets of data. In some embodiments, the corresponding relationship between the fourth type of the electrical parameter and the first type of the transistor parameter may be used to obtain the individual transistor parameter(s) of the first die and/or verify the individual transistor parameter(s) of the first die. For example, the first individual transistor parameter of the first die may be obtained according to the corresponding relationship between the fourth type of the electrical parameter and the first type of the transistor parameter and the fourth type of the individual electrical parameter of the first die.

For other examples, the first individual transistor parameter of the first die may be obtained according to the corresponding relationship between the third type of the electrical parameter and the first type of the transistor parameter and the third type of the individual electrical parameter (or the third type of the electrical parameter) of the first die. Then, the first individual transistor parameter may be verified by the corresponding relationship between the fourth type of the electrical parameter and the first type of the transistor parameter and the fourth type of the individual electrical parameter (or the fourth type of the electrical parameter) of the first die. For example, an introduced individual transistor parameter of the first die can be obtained by using the corresponding relationship between the fourth type of the electrical parameter and the first type of the transistor parameter and the fourth type of the individual electrical parameter (or the fourth type of the electrical parameter) of the first die, and then the introduced individual transistor parameter of the first die is compared with the first individual transistor parameter of the first die (may be obtained according to the corresponding relationship between the third type of the electrical parameter and the first type of the transistor parameter). When the difference between the two individual transistor parameters is within a preset range, it can be considered that the first individual transistor parameter of the first die initially obtained is correct. However, when the difference between the two individual transistor parameters is outside the preset range, it may be necessary to obtain more data from different die groups for verification or to verify the corresponding relationship between other types (such as the fifth type) of electrical parameters and the first type of the transistor parameter.

Thus, through the above many sets of data, a more reliable and wider range corresponding relationship between the first type of the transistor parameters and the third type of the electrical parameter can be obtained, and a more reliable and wider range corresponding relationship between the first type of the transistor parameters and the fourth type of the electrical parameter can be also obtained. In some embodiments, more corresponding relationships can be also obtained, such as the corresponding relationship between the first type of the transistor parameter and a fifth type of the electrical parameter, the corresponding relationship between the first type of the transistor parameter and a sixth type of the electrical parameter, the corresponding relationship between the first type of the transistor parameter and a seventh type of the electrical parameter, the corresponding relationship between a second type of the transistor parameter and the third type of the electrical parameter, the corresponding relationship between a third type of the transistor parameter and the fourth type of the electrical parameter, etc. Of course, more types of overall transistor parameters and more types of overall electrical parameters of the same die group can also be obtained, so as to establish more corresponding relationships between different types of transistor parameters and electrical parameters. And these different types of corresponding relationships can also be verified and corrected with each other, to establish a more accurate and reliable corresponding relationships and database. In some embodiments, the first individual transistor parameter of a first die can be obtained based on the corresponding relationship between the first type of the transistor parameter and the third type of the electrical parameter, the corresponding relationship between the first type of the transistor parameter and the fourth type of the electrical parameter and the first individual electrical parameter.

In some embodiments, based on the large number of corresponding relationships and databases obtained above, an AI model can be established. Of course, this process also involves data screening, pruning, de-noising and other processing processes. The AI model can summarize the mapping relationship between the overall transistor parameters of each type and the overall electrical parameters, so that when the AI model receives the value of a certain type of individual electrical parameter as input, it can more accurately give the value of the individual transistor parameter of the type to be obtained.

Therefore, in some embodiments of the present disclosure, an AI model can be established based on a large amount of data collected on all types/different types of overall transistor parameters and all types/different types of overall electrical parameters to obtain a mapping relationship between different types of overall transistor parameters and overall electrical parameters. Thus, the AI model can give a more accurate and reliable predicted value of the individual transistor parameter according to the question raised (i.e., what type of the individual transistor parameter is needed) and the specific type of individual electrical parameter provided to the AI model. Then, as described in the above method, these specific types of individual transistor parameter(s) are used to match the first chip and the second chip to form the required SOIC.

In some embodiments, the overall transistor parameters and the overall electrical parameters of each die group can be obtained by measurement, for example, by measuring and obtaining the test key on each die group. In this way, a large amount of historical measurement data can be obtained to establish the corresponding relationship between the overall transistor parameters and the overall electrical parameters to form an AI model. Of course, in the process of processing data, there may be some abnormal data or noise data. For example, in the common methods in the field of data processing and screening, the data can also be corrected, screened, de-noised, etc. in the embodiments of the present disclosure. It can also be used for general data fitting, data aggregation and other data processing methods to form a more reliable and scientific corresponding relationship between the overall transistor parameters and the overall electrical parameters and the AI model. In some embodiments, the corresponding relationship between the overall transistor parameters and the overall electrical parameters can also represent the corresponding relationship between the transistor parameters and the electrical parameters to some extent. Therefore, after the individual electrical parameters of a single grain are obtained by measurement, the individual transistor parameters of a single grain of the corresponding type can be obtained according to the corresponding relationship between the transistor parameters and the electrical parameters.

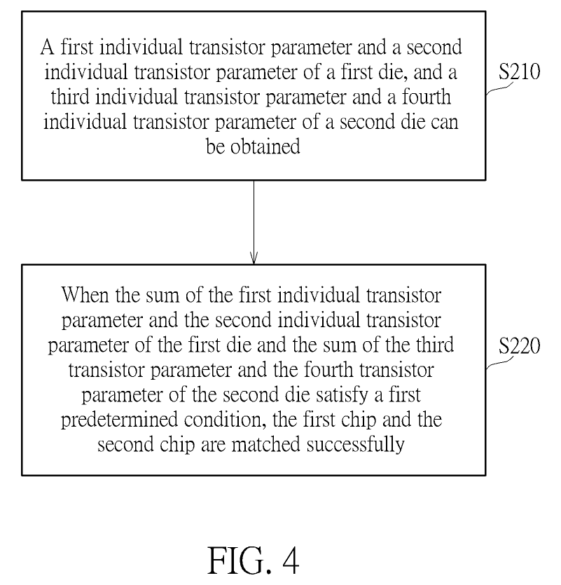

FIG. 4 is a flowchart illustrating a method of matching multiple chips for forming SOICs according to an embodiment of the present disclosure.

In some embodiments, in step 210, a first individual transistor parameter and a second individual transistor parameter of a first die, and a third individual transistor parameter and a fourth individual transistor parameter of a second die can be obtained, both the first individual transistor parameter and the third individual transistor parameter are a first type of transistor parameter, and both the second individual transistor parameter and the fourth individual transistor parameter are a second type of transistor parameter, and the first die is associated with a first chip, and the second die is associated with a second chip. In step 220, when the sum of the first individual transistor parameter and the second individual transistor parameter of the first die and the sum of the third transistor parameter and the fourth transistor parameter of the second die satisfy a first predetermined condition, the first chip and the second chip are matched successfully.

In some embodiments, a first overall transistor parameter and a second overall transistor parameter of the same die group, and a first overall electrical parameter of same die group can be obtained, the first overall transistor parameter is the first type of the transistor parameter, the second overall transistor parameter is the second type of the transistor parameter, and the first overall electrical parameter is a third type of the electrical parameter. In some embodiments, a first corresponding relationship between the first type of the transistor parameter and the third type of the electrical parameter and a second corresponding relationship between the second type of the transistor parameter and the third type of the electrical parameter can be obtained based on the first overall electrical parameter, the second overall transistor parameter and the first overall transistor parameter.

In some embodiments, a first individual electrical parameter of the first die can be obtained, and the first individual electrical parameter is the third type of the electrical parameter. The first individual transistor parameter and the second individual transistor parameter of a first die can be obtained based on the first corresponding relationship and the second corresponding relationship.

In some embodiments, a first overall transistor parameter and a second overall transistor parameter of a first die group, and a third overall electrical parameter and a fourth overall electrical parameter of the first die group can be obtained; the first overall transistor parameter is the first type of the transistor parameter, the second overall transistor parameter is the second type of the transistor parameter, the third overall electrical parameter is a third type of the electrical parameter, and the fourth overall electrical parameter is a fourth type of the electrical parameter. A third corresponding relationship between the first type of the transistor parameter and the third type of the electrical parameter can be obtained based on the first overall electrical parameter and the third overall electrical parameter, and a fourth corresponding relationship between the second type of the transistor parameter and the fourth type of the electrical parameter based on the second overall transistor parameter and the fourth overall electrical parameter. In some embodiments, the first die may or may not belong to the first die group, and the second die may or may not belong to the second die group.

In some embodiments, a first individual electrical parameter and a second individual electrical parameter of the first die can be obtained; the first individual electrical parameter is the third type of the electrical parameter, the second individual electrical parameter is the fourth type of the electrical parameter. The first individual transistor parameter of the first die based on the third corresponding relationship, and the second individual transistor parameter of the first die can be obtained based on the second corresponding relationship.

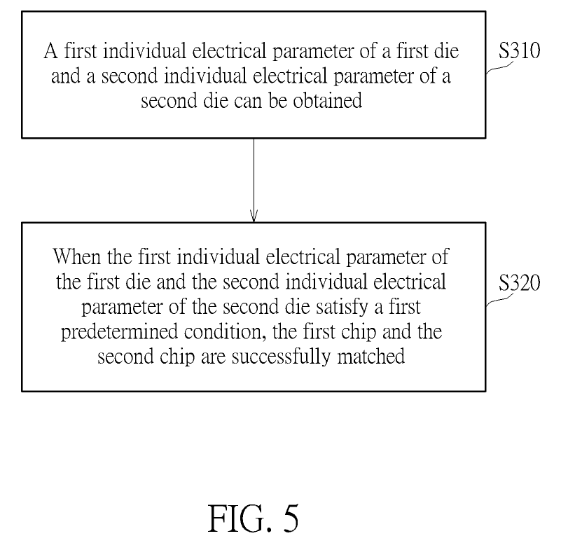

FIG. 5 is a flowchart illustrating a method of matching multiple chips for forming SOICs according to an embodiment of the present disclosure.

S310: a first individual electrical parameter of a first die and a second individual electrical parameter of a second die can be obtained, both the first individual electrical parameter and the second individual electrical parameter are individual electrical parameters of the same type (such as the first type), and the first die is associated with a first chip, and the second die is associated with a second chip.

S320: when the first individual electrical parameter of the first die and the second individual electrical parameter of the second die satisfy a first predetermined condition, the first chip and the second chip are successfully matched.

In some embodiments, for example, the first individual electrical parameter may be the speed of the die, and the second individual electrical parameter is of the same type as the first individual electrical parameter, so the second individual electrical parameter is also the speed of the die. For another example, the first individual electrical parameter may be the leakage of the die, and the second individual electrical parameter is of the same type as the first individual electrical parameter, so the second individual electrical parameter is also the leakage of the die. Therefore, in the embodiment of the present disclosure, individual electrical parameters of the same type are selected to compare and match two chips.

In some embodiments, the first predetermined condition may be that the difference between the first individual electrical parameter and the second individual electrical parameter is less than a first predetermined threshold, or the difference is within a first predetermined range, or the ratio between the first individual electrical parameter and the second individual electrical parameter is within a predetermined range, etc.

In some embodiments, a third individual electrical parameter of the first die and a fourth individual electrical parameter of the second die may also be obtained, wherein the third individual electrical parameter and the fourth individual electrical parameter are individual electrical parameters of the same type (such as the second type), and the type of the third individual electrical parameter (or the fourth individual electrical parameter) is different from the type of the first individual electrical parameter (or the second individual electrical parameter). For example, the type of the first individual electrical parameter (or the second individual electrical parameter) is the speed of the die, and the type of the third individual electrical parameter (or the fourth individual electrical parameter) is the oxidation thickness of the die. Therefore, in subsequent steps, in addition to determining whether the first individual electrical parameter of the first die and the second individual electrical parameter of the second die satisfy the predetermined conditions, it may also be determined whether the third individual electrical parameter of the first die and the fourth individual electrical parameter of the second die satisfy the first predetermined condition or other predetermined condition (such as the second predetermined condition). Of course, in the embodiment of the present disclosure, the fifth individual electrical parameter, the sixth individual electrical parameter, or more individual electrical parameters, etc. can also be obtained, so as to be used for chip matching judgment. The embodiments of the present disclosure do not limit the number of individual electrical parameters obtained and the number of individual electrical parameter types.

In some embodiments, for example, when the third individual electrical parameter of the first die and the fourth individual electrical parameter of the second die can also be obtained, the method in this embodiment can also include comparing the third individual electrical parameter and the fourth individual electrical parameter. Therefore, in addition to judging whether the first individual electrical parameter of the first die and the second individual electrical parameter of the second die satisfy the first predetermined condition, it is also necessary to judge whether the third individual electrical parameter of the first die and the fourth individual electrical parameter of the second die satisfy the same or different predetermined condition. For example, when (a) the first individual electrical parameter of the first die and the second individual electrical parameter of the second die satisfy the first predetermined condition, and when (b) the third individual electrical parameter of the first die and the fourth individual electrical parameter of the second die satisfy the same or different predetermined condition, the first chip and the second chip are successfully matched. Therefore, when (a) and (b) are both met, the first chip and the second chip are successfully matched; when either (a) or (b) is not met, the first chip and the second chip fail to match.

In some embodiments, the first chip and the second chip may be manufactured based on the same wafer or based on different wafers. In some embodiments, the first chip may be an IP core of a first type, and the second chip may be an IP core of a second type. For example, the first chip may be a CPU IP core, and the second chip may be a GPU IP core, a memory IP core or a power management IC (PMIC) IP core. In other embodiments of the present disclosure, the first chip and the second chip may be an IP core of the same type. However, the types of the first chip and the second chip do not limit the scope of the present disclosure.

In the process of manufacturing from wafers to dies and then forming chips, various tests may be performed, such as a wafer acceptance test (WAT), a chip probe (CP) test and/or a final test (FT). The parameters and data desired in the embodiments of the present disclosure may be obtained through one or more tests.

In conclusion, the present disclosure provides a method of matching multiple chips for forming SOICs. Since all chips of an SOIC have matching characteristics, the performance of the SOIC can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of matching multiple chips for forming a System-on-Integrated-Chips (SOIC), comprising:
obtaining a first individual transistor parameter of a first die and a second individual transistor parameter of a second die; wherein the first individual transistor parameter and the second individual transistor parameter are a first type of transistor parameter, the first die is associated with a first chip, and the second die is associated with a second chip; and
matching the first chip and the second chip successfully when the first individual transistor parameter of the first die and the second transistor parameter of the second die satisfy a first predetermined condition.

2. The method of claim 1, wherein the first predetermined condition comprises the difference between the first individual transistor parameter and the second individual transistor parameter is within a first predetermined range.

3. The method of claim 2, further comprising:
obtaining a third individual transistor parameter of the first die and a fourth individual transistor parameter of the second die, wherein the third individual transistor parameter and the fourth individual transistor parameter are a second type of transistor parameter; and
matching the first chip and the second chip successfully when the first individual transistor parameter of the first die and the second transistor parameter of the second die satisfy a first predetermined condition, and the third individual transistor parameter of the first die and a fourth individual transistor parameter of the second die satisfy a second predetermined condition.

4. The method of claim 3, wherein the first type is different from the second type, and the first predetermined condition is different from the second predetermined condition.

5. The method of claim 1, further comprising:
obtaining a first overall transistor parameter of a first die group and a first overall electrical parameter of the first die group wherein the first overall transistor parameter is the first type of the transistor parameter, and the first overall electrical parameter is a third type of the electrical parameter; and
obtaining a first corresponding relationship between the first type of the transistor parameter and the third type of the electrical parameter based on the first overall electrical parameter and the first overall transistor parameter.

6. The method of claim 5, further comprising:
obtaining a first individual electrical parameter of the first die, wherein the first individual electrical parameter is the third type of the electrical parameter; and
obtaining the first individual transistor parameter of a first die based on the first corresponding relationship and the first individual electrical parameter.

7. The method of claim 5, further comprising:
obtaining a second individual electrical parameter of the second die, wherein the second individual electrical parameter is the third type of the electrical parameter; and
obtaining the second individual transistor parameter of a second die based on the first corresponding relationship and the second individual electrical parameter.

8. The method of claim 6, further comprising:
obtaining a second overall electrical parameter of the first die group, wherein the second overall electrical parameter is a fourth type of the electrical parameter; and
obtaining a second corresponding relationship between the first type of the transistor parameter and the fourth type of the electrical parameter based on the first overall electrical parameter and the second overall transistor parameter.

9. The method of claim 8, further comprising:
obtaining a third individual electrical parameter of the first die, wherein the third individual electrical parameter is the fourth type of the electrical parameter; and
obtaining the first individual transistor parameter of a first die based on the first corresponding relationship, the second corresponding relationship, the first individual electrical parameter and the third individual electrical parameter.

10. The method of claim 5, further comprising:
obtaining a third overall transistor parameter of a second die group and a third overall electrical parameter of the second die group, wherein the third overall transistor parameter is the first type of the transistor parameter, and the third overall electrical parameter is the third type of the electrical parameter; and
obtaining a third corresponding relationship between the first type of the transistor parameter and the third type of the electrical parameter based on the third overall transistor parameter and the third overall electrical parameter.

11. The method of claim 10, further comprising:
obtaining a first individual electrical parameter of the first die, wherein the first individual electrical parameter is the third type of the electrical parameter; and
obtaining the first individual transistor parameter of a first die based on the first corresponding relationship, the second corresponding relationship and the first individual electrical parameter.

12. The method of claim 10, further comprising:
establishing an AI model according to at least the first corresponding relationship and the second corresponding relationship, wherein the AI model comprises at least the corresponding relationship between the first type of the transistor parameter and the third type of the electrical parameter.

13. The method of claim 12, further comprising:
obtaining a first individual electrical parameter of the first die, wherein the first individual electrical parameter is the third type of the electrical parameter; and
obtaining the first individual transistor parameter of a first die based on AI model and the first individual electrical parameter.

14. The method of claim 1, wherein the type of the transistor parameter comprises a threshold voltage, a channel impedance, a contact resistance, an on-current, an off-current, a transconductance, an output conductance, a gate capacitance, a source-drain resistance, or a breakdown voltage.

15. The method of claim 5, wherein the type of the electrical parameter comprises a speed, a leakage, an oxidation thickness, a metal line width, a gate length, a minimum operation voltage, a resistivity, a conductivity, a dielectric constant, a carrier concentration, or a mobility.

16. A method of matching multiple chips for forming a System-on-Integrated-Chips (SOIC), comprising:
obtaining a first individual transistor parameter and a second individual transistor parameter of a first die, and a third individual transistor parameter and a fourth individual transistor parameter of a second die, wherein the first individual transistor parameter and the third individual transistor parameter are a first type of transistor parameter, and the second individual transistor parameter and the fourth individual transistor parameter are a second type of transistor parameter, and wherein the first die is associated with a first chip, and the second die is associated with a second chip; and
matching the first chip and the second chip successfully when the sum of the first individual transistor parameter and the second individual transistor parameter of the first die and the sum of the third transistor parameter and the fourth transistor parameter of the second die satisfy a first predetermined condition.

17. The method of claim 16, further comprising:
obtaining a first overall transistor parameter and a second overall transistor parameter of a first die group, and a first overall electrical parameter of the first die group, wherein the first overall transistor parameter is the first type of the transistor parameter, the second overall transistor parameter is the second type of the transistor parameter, and the first overall electrical parameter is a third type of the electrical parameter; and
obtaining a first corresponding relationship between the first type of the transistor parameter and the third type of the electrical parameter and a second corresponding relationship between the second type of the transistor parameter and the third type of the electrical parameter based on the first overall electrical parameter, the second overall transistor parameter and the first overall transistor parameter.

18. The method of claim 17, further comprising:
obtaining a first individual electrical parameter of the first die, wherein the first individual electrical parameter is the third type of the electrical parameter; and
obtaining the first individual transistor parameter and the second individual transistor parameter of a first die based on the first corresponding relationship and the second corresponding relationship.

19. The method of claim 16, further comprising:
obtaining a first overall transistor parameter and a second overall transistor parameter of a first die group, and a third overall electrical parameter and a fourth overall electrical parameter of a first die group and/or a second die group, wherein the first overall transistor parameter is the first type of the transistor parameter, the second overall transistor parameter is the second type of the transistor parameter, the third overall electrical parameter is a third type of the electrical parameter, and the fourth overall electrical parameter is a fourth type of the electrical parameter; and
obtaining a third corresponding relationship between the first type of the transistor parameter and the third type of the electrical parameter based on the first overall electrical parameter and the third overall electrical parameter, and a fourth corresponding relationship between the second type of the transistor parameter and the fourth type of the electrical parameter based on the second overall transistor parameter and the fourth overall electrical parameter.

20. The method of claim 19, further comprising:
obtaining a first individual electrical parameter and a second individual electrical parameter of the first die, wherein the first individual electrical parameter is the third type of the electrical parameter, and the second individual electrical parameter is the fourth type of the electrical parameter; and
obtaining the first individual transistor parameter of the first die based on the third corresponding relationship, and the second individual transistor parameter of the first die based on the second corresponding relationship.
